(19) United States
(12) Patent Application Publication
(10) Pub. No.: US 2011/0041659 A1
(43) Pub. Date: Feb. 24, 2011

(54) PORTABLE DUCT BOARD CUTTING TABLE

(76) Inventor: Dennis Clifford Williams, Cleveland, GA (US)

Correspondence Address: MITCH HARRIS, LLC - GENERAL, P.O. BOX 7998, ATHENS, GA, 30604, US

(21) Appl. No.: 12/545,608

(22) Filed: Aug. 21, 2009

(51) Int. Cl. B26D 1/10; B26D 7/02; B26D 7/27

(52) U.S. Cl. 83/13; 83/522.11; 83/455; 83/648; 83/614; 83/829

(57) ABSTRACT

A duct board cutting table provides accurate cutting of duct board while providing portability and moderate cost. A table top, which is generally large enough to accept most of a sheet of duct board, has a cross-rail assembly mounted above it that slides along the length of the duct board. A duct board cutting tool slides along the length of the cross-rail assembly, which is along the width of the duct board, in order to move the tool's blade through the duct board to make a cut. The tool may be a hand tool, with a tool fixture provided with the table that can slidably mount the hand tool within the cross-rail assembly at multiple heights above the table to accommodate duct board of various thicknesses. A stopping mechanism can be included to stop the cross-rail assembly at multiple cutting positions using removable stop blocks.

### BACKGROUND OF THE INVENTION

1. Field of the Invention

The present invention relates generally to tools for heating ventilation and air conditioning (HVAC) system fabrication, and more particularly, to a table for cutting duct board.

2. Description of the Related Art

Duct board, generally made of fiberglass insulation or foam board with layers of metal foil bonded on at least one of the faces, is replacing galvanized steel as a material of choice in fabricating ductwork for heating and air conditioning systems. The duct board is lighter and has inherent insulating properties and therefore does not typically require additional insulation and the effort required to install the insulation around the ductwork.

The main air handler plenums, as well as rectangular and quasi-circular ducts can be fabricated from duct board, which is available in several standard thicknesses. The duct board must be cut in order to form the multiple sides of the ducts and plenums, and ideally, to avoid seam taping, the duct board is cut so that the metal foil on one side of the duct board remains intact. Material is removed so that corners can be formed from the cut duct board. The cut duct board can then be folded to form the final ductwork.

Presently, there are two alternatives for cutting duct board. Hand tools are available at moderate cost, and include a registration surface and a cutting blade that extends below the registration surface. The registration surface is slid along the top of the duct board, with the cutting blade extending into the duct board just short of the outer metal foil layer. The hand tool technique is understandably difficult, as the operator must be very skilled and steady, or improvised guides, such as squares or boards, may be used to try to prevent the tool from sliding away from the desired cut line. Further, the duct board sheets are large and easily damaged, since the operator must generally lean on the sheet in order to cut it with a hand tool and the sheet is generally placed on the floor, and can be damaged unless the floor is clear of debris, which is not generally true of construction sites. Finally, in order to cut the outer metal foil layer of the duct board, the operator generally performs a separate cut using a knife by standing the duct board on edge to cut the foil after making a cut through the insulating material.

The second alternative is a large grooving machine that performs multiple simultaneous cuts automatically by drawing a piece of duct board through multiple blades. The grooving machine technique provides accurate cuts that are well-registered to each other and straight, but the grooving machine is large and weighs on the order of a ton. Therefore, the grooving machine is not easily carted from job-site to job-site and if it is towed on a trailer, will generally remain outside the job-site, e.g., in a driveway or alley while the HVAC work is performed.

Therefore, it would be desirable to provide a portable cutting device for cutting duct board that provides straight, repeatable cuts, and that selectively retains or cuts the outer metal foil layer, without requiring a high degree of operator skill. It would further be desirable to provide a device for cutting duct board that provides accurate registration between multiple cuts.

### SUMMARY OF THE INVENTION

The objective of providing a portable cutting device for duct board is accomplished in a duct board cutting table and its method of operation. Various features can be included to provided for registration and straight, repeatable cuts for folds and for separating the duct board.

The duct board cutting table includes a table top having a stabilizing surface for accepting a sheet of duct board. A cross-rail assembly slides along the length of the table top and carries a duct board cutting tool that slides along the length of the cross-rail assembly and across the width of the duct board. The tool may be a hand tool that is secured in a tool mount that can be removed from the cross-rail assembly and slid into the cross-rail assembly at various heights to accommodate various duct board cutting tools that have different blade lengths and positions for the various standard thicknesses of duct board.

The duct board cutting table may also include a stopping mechanism for stopping the cross-rail assembly at multiple cutting locations, which may be a keying mechanism that secures the cross-rail assembly when disposed at stop block that has a mating feature, e.g., a pin that is mated with a complementary mating feature, e.g., a hole disposed along the edge of the table. A rule may be provided to facilitate placing the multiple stop blocks prior to cutting.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1 is an illustration of a duct board cutting table in accordance with an embodiment of the invention.

FIG. 2 is an illustration of the duct board cutting table of FIG. 1 in operation.

FIG. 3A and FIG. 3B are illustrations of a duct board cutting tool assembly 14 of FIG. 1 in accordance with an embodiment of the invention.

FIG. 4 is an illustration depicting insertion of duct board cutting tool assembly 14 being inserted into cross-rail assembly 20 of FIG. 1.

FIG. 5A and FIG. 5B are an end view and a side view, respectively, of the front end of cross-rail assembly 14, depicting details of a stopping mechanism in accordance with an embodiment of the invention.

FIG. 6 is an illustration depicting details of extension arm 15 in accordance with an embodiment of the invention.

FIG. 7 is an illustration depicting details of duct board cutting tool assembly 14 of FIG. 1.

### DESCRIPTION OF ILLUSTRATIVE EMBODIMENT

The present invention is a duct board cutting table that facilitates accurate and rapid construction of ducting and plenums from duct board, while providing portability for transportation between job-sites. The duct board cutting table provides a stable support surface for the duct board and a cross-rail assembly that slides along the length of the table. A duct board cutting tool assembly slides along the length of the cross-rail assembly to cut the duct board across its width. A stopping scheme is provided to set up multiple cut locations along the length of the duct board before beginning cutting operations, and the cross-rail assembly is securely locked at each cutting position by a keying mechanism.

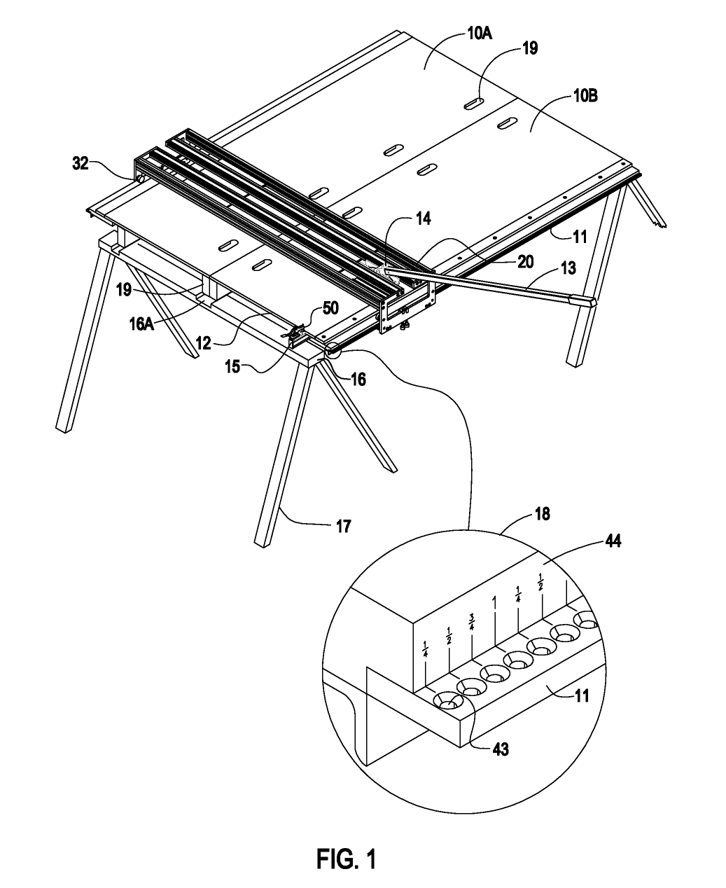

Referring now to FIG. 1, a portable duct board cutting table in accordance with an embodiment of the invention is illustrated. A top surface 12 of the duct board cutting table provides a stable supporting surface for a sheet of duct board. Standard duct board sheets are generally four feet in width and ten feet in length. The exemplary top surface 12 is approximately four feet in width by eight feet in length, and can be separated into two approximately two foot by eight foot portions 10A and 10B in order to make it possible to place the table top 12 in a standard work vehicle bed. Handle holes 19 are provided for ease of carrying, and pins (not shown) and mating holes (not shown) are provided along the mating edge of portions 10A and 10B to align and secure them together during use. A locking mechanism can be provided on the underside of table top 12 to lock portions 10A and 10B together. An extension arm 15 is provided for supporting the remaining two feet of duct board length, and is retractably connected to the underside of table top 12, so that extension arm 15 can be retracted when working with smaller pieces of duct board, or during transport. A clamp 50 is disposed at the end of extension arm 15 for securing a piece of duct board. Removable or retractable stand legs 17 are provided on the bottom of table top 12, which in the exemplary embodiment are in the form of sawhorses with top members 16 having slots 16A provided across their widths. Slots 16A receive support beams 19 provided across the length of table top 12 on the bottom side of table top 12.

A cross rail assembly 20 is slidably coupled to table top 12 and includes rollers 32 for allowing cross rail assembly 20 to slide along the length of table top 12. Cross rail assembly 20 includes stiffeners across its width to prevent bowing of cross rail assembly 20 when cutting duct board. A tool assembly 14 slidably mounted within cross rail assembly 20 receives duct board cutting tools having blades of various types and lengths for cutting various thicknesses of duct board. A handle 13 is attached tool assembly 14 with a rotatable link that permits handle 13 to accommodate different vertical hand positions as the operator slides tool assembly 14 forward to perform cuts. A perforated rail 11, disposed along the front edge of table top 12, provides for a stopping mechanism that allows an operator to set up multiple cutting locations in advance of cutting operations, so that a set of cuts can be easily repeated. Callout 18 illustrates details of perforated rail 11, with holes 43 provided at ¼ inch intervals. A ruled scale 44 is provided above holes 43 on a vertical edge of table top 12, to guide the operator in the placement of stop blocks along perforated rail 11, which will be explained in greater detail below.

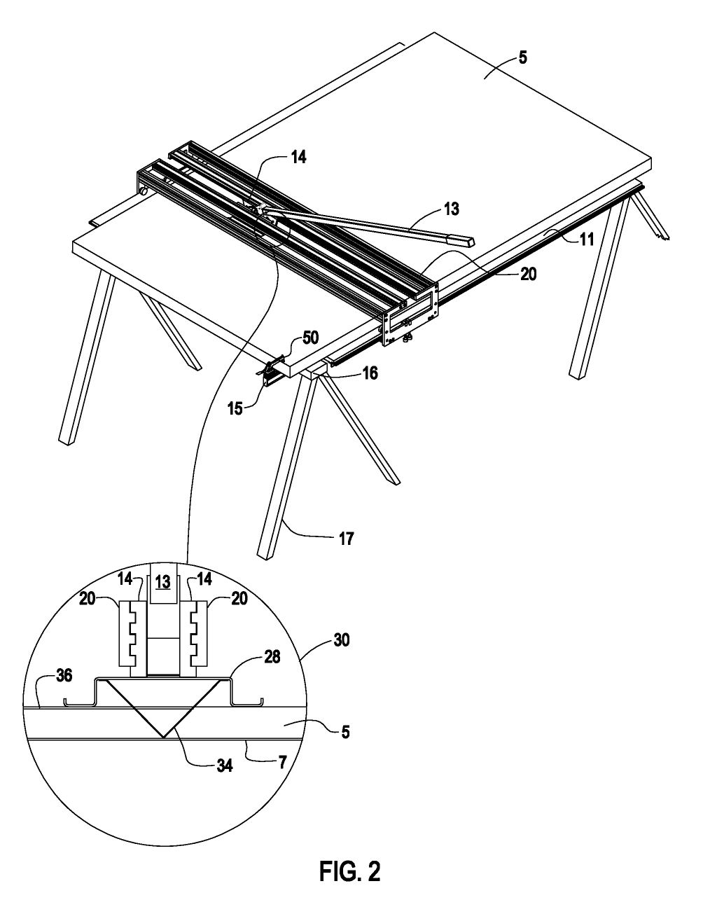

Referring now to FIG. 2, the duct board cutting table of FIG. 1 is illustrated in use to make cuts in duct board 5. Duct board 5 is secured by a clamp 50 disposed at the end of extension arm 15 and callout 30 illustrates a cross-section within duct board 5, in which a blade 34 of a cutting tool 28 is embedded during the cutting operation. The height of the blade 34 is determined by the length of blade 34 itself, which differs for cutting tools 28 adapted for different duct board thicknesses, and the height at which cutting tool 28 is secured above duct board 5. Cutting tool 28 generally also has a registration surface 36 that prevents blade 34 from penetrating the bottom foil 7 of duct board 5, unless additional pressure is applied in a vertical direction, which is used to perform a final cut that removes any excess duct board from the piece. Tool assembly 14 has features that will be described in further detail below that facilitates making the final cut in duct board 5 by applying additional pressure to cutting tool 28, while permitting cutting tool 28 to travel vertically within tool assembly 14 sufficient to cut bottom foil 7. Alternatively, a separate hand tool can be used to cut bottom foil 7 once the final cut is made by blade 34.

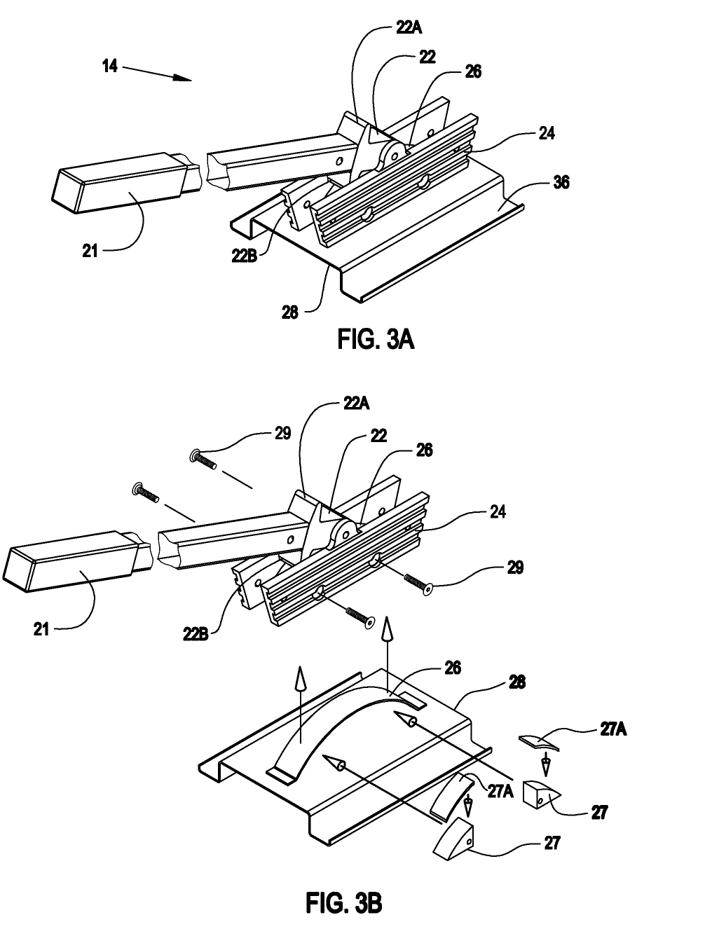

Referring now to FIG. 3A, details of tool assembly 14 are shown. Handle 21 is threaded into rotatable link 22, which detachably attaches handle 21 to tool assembly 14. Cams 22A and 22B are provided on rotatable link to apply downward pressure to a handle 26 of a hand operable duct board cutting tool 28, which is inserted into tool assembly 14 in the exemplary embodiment. When making a final cut to sever the outer foil layer of a piece of duct board, cam 22A or 22B engages handle 26 to press it down and force the blade through the outer (bottom with respect to the table) foil. However, the present invention also contemplates tool assembly 14 forming a tool by inclusion of a suitable blade and optionally a registration surface, so that the duct board cutting tool used in other embodiments of the present invention may not include handle 26 and other mechanisms suitable for selecting between cutting foil and not cutting foil can alternatively be provided. Slide 24 including sets of grooves and ridges on the sides of tool assembly 14 mate with a complementary set of grooves and ridges disposed on cross-rail assembly 20. The ends of slide 24 are angled to ease insertion of slide assembly 24 into cross-rail assembly, since one set of grooves and ridges can be engaged at a time before requiring others to be engaged. Multiple mating positions of slides 24 within cross rail assembly 20 provide height adjustment that positioning tool assembly 14 for different duct board thicknesses, as will be described in further detail below. In the depicted embodiment, two rotatable links 22 are provided, one on each end of tool assembly 14, so that tool assembly 14 may be rotated 180 degrees for some non-symmetrical cutting tools that are rotated to make complementary cuts. However other embodiments of the invention may include only one rotatable link 22.

Referring now to FIG. 3B, attachment of duct board cutting tool 28 into tool assembly 14 is shown. Spacer blocks 27 are adapted to the shape of the volume defined by the inside grasping portion of handle 26, and are threaded to receive bolts 29 that pass through slides 24 to secure duct board cutting tool 28 against movement within tool assembly 14. Compressible spacers 27A made from a foam material or other suitable compressive structure, are provided to permit handle and duct board cutting tool 28 to move downward slightly when cam 22A or 22B forces handle 26 downward to cut the bottom foil of ductboard. A spring loaded arrangement or other suitable flexible assembly can be used in places of compressible spacers 27A to provide a restoring force against pressure applied by cam 22A or 22B.

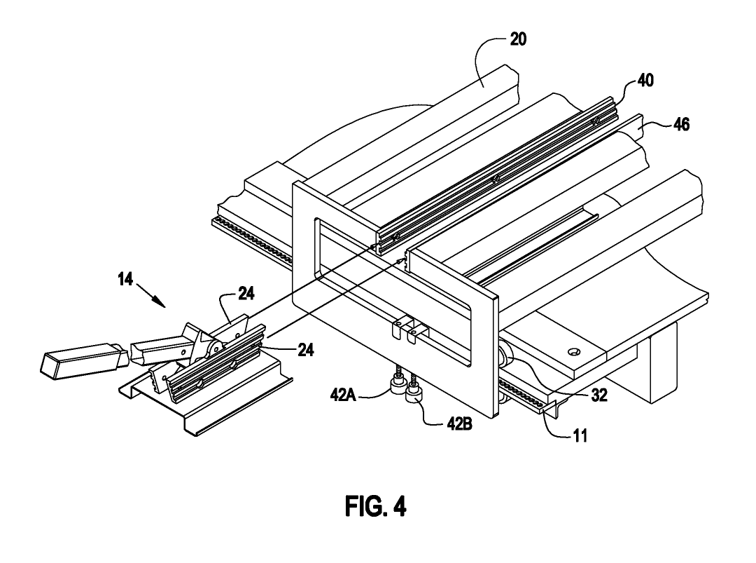

Referring now to FIG. 4, insertion of tool assembly 14 into cross-rail assembly 20 is shown. Tool assembly 14 can be easily removed for interchanging tools with different cutting shapes and heights. Slides 24 interface with complementary slides 40 mounted on cross-rail assembly 20 and interlock at different heights to provide adjustments for different duct board thicknesses, such as 1″, 1.5″ and 2″ duct board thicknesses. A stopping mechanism provided in the duct board table of the present invention includes two spring loaded keying mechanisms 42A and 42B that are operated to allow movement of cross-rail assembly 20 against stop blocks inserted in perforated rail 11 as will be described in further detail below.

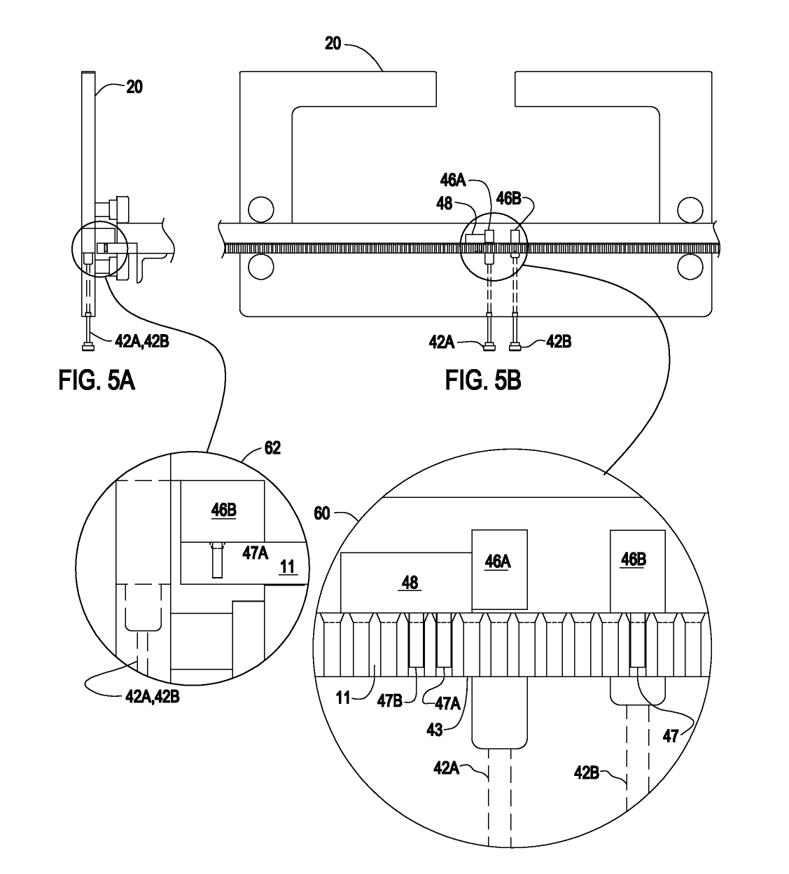

Referring now to FIG. 5A and FIG. 5B, details of the front end of cross-rail assembly 20 are shown in an inside cross-sectional view and a side view, respectively. Keying mechanism 42A includes a block portion 46A that has a face that abuts stop block 48 when cross-rail assembly 20 is secured in place for a cut. Block portion 46A does not contact perforated rail 11, so that cross-rail assembly 20 can be slid along the length of the table (between stop blocks 48) without raising keying mechanism 42A. Stop block 48 has pins 47A and 47B that engage with other holes 43 to prevent stop block 48 from moving. Another keying mechanism 42B also includes a block portion 46B that has a pin 47. Keying mechanism 42B locks cross-rail assembly 20 in place when released and pin 47 engages with one of holes 43. Holes 43 have conically tapered top portions to facilitate insertion of stop block pins 47A and 47B, as well as pin 47 of block portion 46B. Pins 47A and 47B can be off center with respect to the depth of stop block 48, so that stop block cannot be accidentally reversed and the projection of the front of stop block 48 over the front of perforated rail facilitates removal of stop block 48 by hand.

In order to secure cross-rail assembly 20 to make a cut, the operator slides cross rail assembly 20 toward the operator's right (left in FIG. 5A) until block portion 46A strikes the next stop block. The operator then releases keying mechanism 42B locking cross-rail assembly 20 in place by engaging pin 47 with one of holes 43. The operator then makes a cut by sliding tool assembly 14 using handle 13 across a sheet of duct board. In order to move cross rail assembly 20 to the operator's right (to the left in FIG. 5B and callout 60), the operator raises keying mechanisms 42A and 42B to clear stop block 48, then releases keying mechanism 42A and continues to move cross-rail assembly 20 until block portion 46A contacts a next stop block. The operator then releases keying mechanism 42B to lock cross-rail assembly 20 in place and makes the next cut. The process is repeated until all of the stop blocks have been engaged and all of the cuts have been made. Callout 62 shows details in the side view of FIG. 5A.

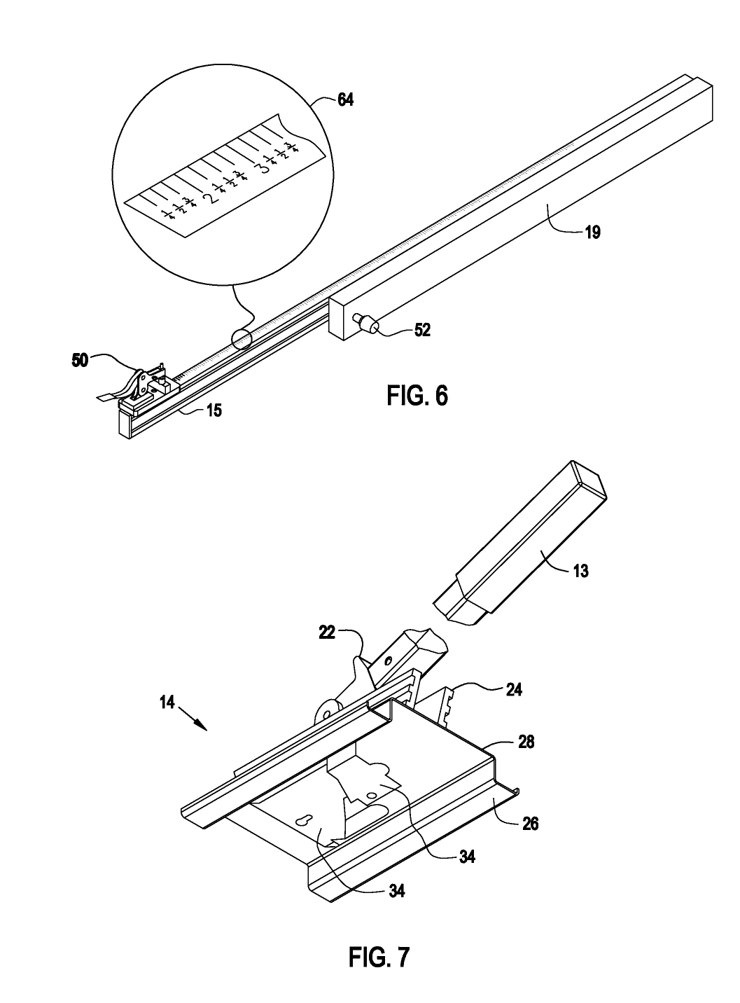

Referring now to FIG. 6, details of extension arm 15 in FIGS. 1 and 2 are shown. A clamp 50 is attached to the end of extension arm 15 for securing duct board. A thumbscrew 52 secures extension arm 15 to one of support beams 19 disposed under table top 12. When thumbscrew 52 is loosened, a slideable distal end of thumbscrew 52, such as a bolt head, is freed to slide within a channel in the body of extension 15, permitting extension to slide along support beam 19. When thumbscrew 52 is tightened, extension arm 15 is locked in place. Extension arm may include a ruled scale as shown in callout 64 to facilitate setting of the length of extension of extension arm 15. A block provided on extension arm 15 and under clamp 50 aligns with the top side of table top 12 so that a piece of duct board is clamped at the same height as table top 12. The underside of table top 12 is milled to receive the block and any other features at the end of extension arm 15 at the base of clamp 50 so that extension arm 15 can be retracted to the edge of table top 12 for transport.

Referring now to FIG. 7, details of an exemplary duct board cutting tool 28 mounted in tool assembly 14 are shown. Blade 34 may include multiple blade portions, depending on the type of cut and tool. Blade 34 extends below registration surfaces 26 to the depth of the desired cut for the particular tool.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A duct board cutting table, comprising:
a table top having a stabilizing surface for supporting a sheet of duct board; and
a cross-rail assembly slidably mounted above the stabilizing surface and adapted for receiving a duct board cutting tool, and securing the duct board cutting tool such that a blade of the duct board cutting tool does not penetrate a bottom surface of the sheet of duct board, wherein the cross-rail assembly is slideable along a length of the table top and slidably mounts the duct board cutting tool, wherein the duct board cutting tool is slideable across the width of the table top.

2. The duct board cutting table of claim 1, wherein the table top has a width substantially equal to the width of a standard duct board size and a length greater than or equal to 75 percent of a length of the standard duct board size.

3. The duct board cutting table of claim 2, further comprising an adjustable extension arm for extending the length of the duct board cutting table to substantially 100 percent of the length of the standard duct board size.

4. The duct board cutting table of claim 3, wherein an end of the adjustable extension arm includes a clamping mechanism for securing a sheet of duct board.

5. The duct board cutting table, further comprising:
a tool mount slidably mounted in the cross-rail assembly; and
a duct board cutting tool detachably mounted to the tool mount.

6. The duct board cutting table of claim 5, wherein the duct board cutting tool is a hand tool having a handle defining a volume for receiving fingers of an operator's hand.

7. The duct board cutting table of claim 6, wherein the tool mount includes one or more fixtures for mounting within the volume, whereby the hand tool is mounted to the tool mount.

8. The duct board cutting table of claim 1, further comprising a handle having a length substantially equal to or greater than the width of the standard duct board size, wherein the handle is rotatably coupled to the duct board cutting tool with a rotational axis parallel to a length of the table top.

9. The duct board cutting table of claim 1, further comprising a stopping mechanism for securing the cross-rail assembly at multiple cut locations along the length of the table top.

10. The duct board cutting table of claim 9, wherein the stopping mechanism includes multiple mating features for receiving multiple stop blocks that engage with the stopping mechanism at the multiple locations.

11. The duct board cutting table of claim 10, wherein the stopping mechanism includes a pair of keying mechanisms, wherein the cross-rail assembly is secured in a direction of the length of the table top when a stop block is disposed adjacent to one of the pair of keying mechanisms, and wherein the keying mechanisms are operable to clear the stop block to release the cross-rail assembly to move along the length of the table top.

12. The duct board cutting table of claim 11, wherein at least one of the pair of keying mechanisms includes a complementary mating feature that releasably mates with the mating features of the stopping mechanism to further secure the cross-rail assembly against movement along the length of the table top.

13. The duct board cutting table of claim 10, wherein the multiple mating features are disposed on a rail along the length of the table top at a front edge thereof, and further comprising a ruled strip indicating a distance along the length of the table top, whereby the position of the mating features are visibly indicated and the stop blocks can be placed without reference to another measuring device.

14. The duct board cutting table of claim 1, further comprising a set of detachable or collapsible legs mechanically coupled to the bottom of the table top, whereby a volume occupied by the duct board cutting table can be reduced for transport by detaching or collapsing the legs.

15. The duct board cutting table of claim 1, wherein the duct board cutting tool is slidably retained in the cross-rail assembly by a tool mount having mating grooves and ridges that interface with other mating grooves and ridges disposed along a length of the cross-rail assembly.

16. The duct board cutting table of claim 15, wherein the mating grooves and ridges of the tool mount and the other mating grooves and ridges of the cross-rail assembly have multiple mating positions corresponding to multiple heights of the duct board cutting tool above the stabilizing surface of the table top, whereby the tool mount can be slid from the cross-rail assembly and re-inserted at a different cutting height.

17. The duct board cutting table of claim 1, wherein the table top comprises multiple portions dividing the table top, wherein the multiple portions can be detached from each other for transport of the duct board cutting table.

18. The duct board cutting table of claim 1, wherein the cross rail assembly mounts the duct board cutting tools such that the duct board cutting tool can be displaced vertically to penetrate the bottom surface of the sheet of duct board when pressure is applied from a handle that slides the duct board cutting tool along the cross-rail assembly across the width of the table top.

19. A duct board cutting table, comprising:
a table top having a stabilizing surface for supporting a sheet of duct board;
a cross-rail assembly slidably mounted above the stabilizing surface, wherein the cross-rail assembly is slideable along a length of the table top;
a tool mount slidably mounted in the cross-rail assembly;
a duct board cutting tool detachably mounted to the tool mount;
a handle having a length substantially equal to or greater than the width of the standard duct board size, wherein the handle is rotatably attached to the tool mount with a rotational axis parallel to a length of the table top;
multiple mating features disposed on a rail along the length of the table top at a front edge thereof, wherein the mating features are adapted to receive stop blocks;
a ruled strip indicating a distance along the length of the table top, whereby the position of the mating features are visibly indicated and the stop blocks can be placed without reference to another measuring device;
a stopping mechanism including a pair of keying mechanisms, wherein the cross-rail assembly is secured in a direction of the length of the table top when a stop block is disposed at one of the pair of keying mechanisms, and wherein the keying mechanisms are operable to clear the stop block to release the cross-rail assembly to move along the length of the table top.

20. A method of cutting duct board, comprising:
placing the duct board on a table top having a cross-rail assembly slidably secured thereto;
moving the cross-rail assembly to a cutting location along a length of the table top; and
sliding a duct board cutting tool fixture along a length of the cross-rail assembly and a long a width of the table top, wherein the cutting tool fixture is slidably secured to the cross-rail assembly to move a blade of a duct board cutting tool secured to the cutting tool fixture through the duct board, whereby the duct board is cut.

21. The method of claim 20, further comprising:
placing multiple stop blocks at multiple cutting positions along the length of the table top, by engaging mating features of the stop blocks with other mating features disposed along the length of the table top; and
prior to sliding the duct board cutting tool fixture along the length of the cross-rail assembly to make a cut, engaging a keying mechanism to secure the cross-rail assembly at each of the stop blocks, and performing the sliding at the multiple cutting positions to make multiple cuts.

22. The method of claim 20, further comprising adjusting a height of the duct board cutting tool fixture above the table top by sliding the duct board cutting tool fixture out of the cross-rail assembly and re-inserting the duct board cutting tool fixture at a new height differing from a previous height above the table top.

23. The method of claim 20, further comprising temporarily changing a height of the duct board cutting tool fixture above the table top by applying pressure to a top of the duct board cutting tool within the duct board cutting tool fixture, whereby a blade of the duct board cutting tool penetrates a bottom surface of the duct board.
